(19) United States
(12) Patent Application Publication
(10) Pub. No.: US 2010/0239808 A1
(43) Pub. Date: Sep. 23, 2010

(54) PROCESS FOR PRODUCING A SHEET LIKE ARTICLE, FACILITY FOR PRODUCING A GLIDABLE FIBRE FOR THIS PROCESS, FIBRE FOR USE IN THIS PROCESS AND ALSO SHEETLIKE ARTICLE PRODUCED BY THIS PROCESS

(75) Inventor: Eugen SCHWITTER, Mollis (CH)

Correspondence Address: BROWDY AND NEIMARK, P.L.L.C.;624 NINTH STREET, NW, SUITE 300, WASHINGTON, DC, 20001-5303, US

(73) Assignee: TODI SPORT AG, GLARUS, Glarus (CH)

(21) Appl. No.: 12/454,546

(22) Filed: Jun. 6, 2008

(30) Foreign Application Priority Data
Jun. 6, 2007 (CH) 0899/07

(51) Int. Cl. D04H 13/02; B29C 47/04; B28B 17/02

(52) U.S. Cl. 428/96; 264/177.2; 425/88; 428/373

(57) ABSTRACT

The process serves for producing a sheetlike article, for example a climbing skin (1) for skis, a slide-mat or a velour. Said sheetlike article has at least one glidable surface (4) produced from fibres (5). At least a portion of these fibres (7) is produced from a base material (6) and a glide material (7) uniformly dispersed in said base material (6). The base material (6) is preferably a thermoplastic material. The glide material (7) is admixed to this base material (6) in an extruder. The article produced by this process has gliding properties which are preserved in use.

The invention relates to a process for producing a sheetlike article, for example a climbing skin for skis, a slide-mat or a textile velour, having at least one glidable surface produced from fibres.

The glidable surface of the sheetlike articles mentioned and particularly in the case of climbing skins consists of a fibre material. To enhance the gliding properties, this fibre material is impregnated with a glidant. Glidant impregnation or finishing is done on the final product, i.e. on the climbing skin for example, on an intermediate article or on the fibre material, for example on a yarn or filament. In the case of a climbing skin, the climbing properties can be improved with such an impregnation as well as the gliding properties. However, such a finish or impregnation has the disadvantage that its effect is lost comparatively quickly. The glidant applied is worn away in the use of a climbing skin for example, so that the glidability sought is at least partly lost.

It is an object of the invention to provide a process of the type in question whereby a sheetlike article that avoids the aforementioned disadvantages can be produced.

This object is achieved for a process of the type in question when at least a portion of the fibres is produced from a base material and a glide material uniformly dispersed in said base material.

The process according to the invention provides a sheetlike article whose glidability in use, even prolonged use, undergoes substantially no change. Such sheetlike articles are, in particular, ski or climbing skins, slide-mats and industrial velours for application to slides, ski jumps and also products in industrial fabrication which have a glide-friendly surface and are subject to a certain degree of abrasion. If the surface is worn out in use, the gliding properties persist, since glidants are present on the surfaces of worn fibres as well as unworn fibres. As the fibres undergo a wearing process, correspondingly deeper-lying regions of the glide material become effective. Since the fibres are pervaded, preferably homogeneously, with such glide material, even pronounced wear can cause substantially no reduction in glidability. Glidability is therefore durably preserved. It is therefore essential that the glide material be admixed to the base material at the stage of fibre production. It is another significant advantage of the process according to the invention that production does not become significantly more costly or inconvenient and that existing equipment can continue to be used.

In a further development of the invention, the base material is a thermoplastic material. This is admixed with the glide material before extrusion. All the components are then melted and at the same time homogeneously mixed in the extruder. Extrusion can be through a spinnerette die, as is customary in the case of fibre and filament manufactures. Useful thermoplastic materials include for example PA, PET, PBT or mixtures of various thermoplastic components.

It is also possible for just a proportion of the glidable surface in question to consist of fibres comprising glide material uniformly dispersed in base material. This proportion can be for example 50% or else more or less. Thus, a proportion of the fibres can continue to be made as hitherto customary, without glide material.

Fibres having a fibre diameter of 10 to 500 μm, preferably 100 to 300 μm, will prove particularly useful. The fibres can be short fibres, monofilaments or else multifilaments.

The glidable surface can be produced using not only spun yarns but also twisted yarns. Continuous mono- and multifilaments are also suitable. Spun yarns consist of a large number of fine short fibres. Multifilaments of at least two continuous monofilaments, while monofilaments consist of just one, usually coarse, continuous fibre. Different surfaces can be suitable depending on the type of snow. Cold dry snow requires for example a finer surface texture than wet or spring snow. A rougher surface is advisable for the latter. Fine surfaces can be achieved with a dense weave of fine yarn/filaments. Coarse surface textures, by contrast, are achieved for example with more open weaves and coarser yarns or filaments.

Useful glide materials for admixture to the base material include for example graphite, fluorinated plastics and particularly PTFE, carbon black, silicone plastics or waxes. Mixtures of these materials are also suitable. Mixing, as mentioned earlier, preferably takes place prior to extrusion of the fibre. The proportion of glide material depends on the planned use. This proportion is preferably in the range from 3% to 15%, preferably 5% to 10% and, for example, about 7% by weight.

The invention also provides a facility for producing a glidable fibre for the process according to Claim 1. This facility comprises at least one material feed station, a metering pump, a spinnerette die and at least one drawing unit. The base material and the glide material are fed by way of the material feed station to the metering pump and by way of the latter to the spinnerette die. This ensures that the base material and the glide material are uniformly and, in particular, homogeneously distributed in the fibre. This facility preferably includes at least one extruder in which the base material and the glidant are melted and mixed. This permits particularly simple and homogeneous mixing of the glide material with the base material.

The invention also provides a fibre composed of a base material and a glide material uniformly dispersed in said base material, for use of the process mentioned.

The invention also provides a sheetlike article produced according to the process mentioned. The sheetlike article is, in particular, a climbing skin or a slide-mat. The climbing skin and the slide-mat preferably have a supporting layer on which the glidable surface is secured and forms a pile.

Further advantageous features will be apparent from the accompanying claims, the description which follows and also the drawing.

Operative examples of the invention will now be more particularly elucidated with reference to the drawing, where

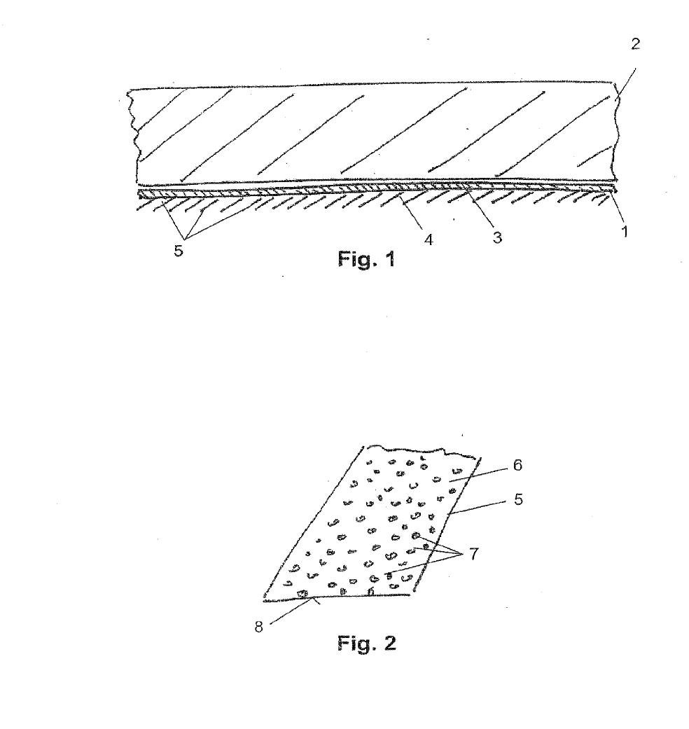

FIG. 1 is a schematic depiction of a section through a portion of a climbing skin, and

FIG. 2 shows an enlarged section through a fibre according to the invention.

FIG. 1 shows a ski 2, for example a touring ski, to which a climbing skin 1 is secured in a conventional manner. This climbing skin 1 has a supporting layer 3 to which a pile 4 of fibres 5 is secured. The fibres 5 can be a monofilament or a multifilament. They can for example also be produced as spun or twisted yarns. Securement to the supporting layer 3 is effected in a conventional manner. In order that the fibres 5 are suitable for a climbing skin 3, they have to be mechanically stressable and must not bend, fold or buckle in use. They also have to have climbing and gliding properties attuned to snow. For this, at least a proportion of the fibres 5 have a glide material 7 uniformly dispersed therein, as shown in FIG. 2 by way of example.

FIG. 2 shows in enlarged depiction a section of fibre 5, consisting of a base material 6 and a glide material 7. The glide material 7 forms a uniform and thus homogeneous dispersion in the base material 6. The glide material 7 is thus also present on the circumference of the fibre 5 and on an end face 8. But the glide material 7 is present in uniform dispersion pervasively and thus also in the interior of the fibre 5.

The base material 6 is, in particular, a thermoplastic material, for example PET, PBT or a polyolefin-based plastic such as polyethylene for example. A mixture of various thermoplastic components is also possible. The glide material 7 is produced for example from a fluorinated plastic, for example PTFE, carbon black, a silicone plastic or a wax. FIG. 2 shows the glide material 7 in the form of parts. The glide material, however, can also form a molecular dispersion. The parts 7 can thus also be of molecular size. However, the glide material 7 can also be present in the form of small parts, for example as graphite parts. The proportion of fibre 5 which is attributable to glide material is in the range of for example 3% to 15% and especially in the region of about 7% by weight. The proportion is at least 0.5% by weight. However, smaller and larger proportions are also possible in principle. Aside from the base material 6 and the glide material 7 other constituents can also be present, examples being stabilizers and dyes.

Since the glide material 7 is present on the surface of the fibre 5 and particularly on the end face 8 as well in the material of the fibre, the glide properties of the pile 4 are preserved even when the fibre 5 is partially worn through use. In the event of wear, correspondingly deeper-lying glide material 7 becomes effective, The special gliding properties of the fibres 5 are thus durably persistent.

The fibres 5 can be produced using a conventional facility comprising a material feed having an upstream metering instrument, spinning extruder, filter, metering pump and a cooling device, one or more drawing units and also a winding device. In the extruder, the base material and the glide material are destructurized and at the same time homogeneously mixed with each other. The glide material 7 is thus admixed to the fibre 5 even as fibre 5 is being produced. The glide material 7 can be admixed as a powder or else as a liquid. Extrusion of the mixed material can be via spinnerette dies, as is customary for fibre and filament manufactures. The further processing steps, for example drawing and also winding, are well known to a person skilled in the art and therefore need not be elucidated here.

The process or the fibre 5 is particularly useful for producing the abovementioned climbing skin 1. In principle, however, other flat articles having a surface of fibres 5 can be produced as well. The sheetlike article can also be for example a slide-mat on which articles are conveyed in a transportation device for example. The flat article can be a velour and hence a textile product and particularly a woven fabric with cut loops or a knitted fabric. The slide-mat mentioned and the climbing skin mentioned can each be a velour, but this is not mandatory.

### LIST OF REFERENCE SIGNS

1 Climbing skin
2 Ski
3 Supporting layer
4 Pile
5 Fibre
6 Base material
7 Glide material
8 End face

1. Process for producing a sheetlike article, for example a climbing skin for skis, a slide-mat or a textile velour, having at least one glidable surface produced from fibres, wherein at least a portion of these fibres (5) is produced from a base material and a glide material uniformly dispersed in said base material.

2. Process according to claim 1, wherein the base material is a thermoplastic material and the glide material is admixed to the base material upstream of an extruder.

3. Process according to claim 1, wherein the glidable surface is produced from short fibres, monofilaments or multifilaments.

4. Process according to claim 1, wherein fibres with said glide material and fibres without this glide material are mixed, so that said glidable surface consists of a mixture of such fibres.

5. Process according to claim 1, wherein fibres used have a fibre diameter of 10 to 500 μm, preferably 100 to 300 μm.

6. Process according to claim 1, wherein fibres having a length of at least 10 mm or continuous filament fibres are used.

7. Process according to claim 1, wherein the proportion of the fibre which is attributable to the glide material is greater than 0.5% by weight.

8. Process according to claim 1, wherein the fibres are unidirectional.

9. Process according to claim 1, wherein the glide material is graphite, a fluorinated plastic, PTFE, carbon black, a silicone plastic, a wax or some other glide-promoting substance or a mixture of two or more thereof.

10. Process according to claim 9, wherein the proportion of the fibre which is attributable to the glide material is 3% to 15%, preferably 5% to 10% and preferably 7% by weight.

11. Facility for producing a glidable fibre for the process according to claim 1, wherein said facility has at least the following processing stations:
a mixing and material feed station for polymers, glidants and additives
at least one extruder
a filter system
a metering pump
at least one spinnerette die
a cooling device and at least one drawing unit.

12. Facility according to claim 11, wherein at least one winding device is disposed downstream of the drawing unit.

13. Facility according to claim 11, wherein it has at least one extruder in which the base material and the glide material are melted and are mixed together.

14. Fibre composed of a base material and a glide material uniformly dispersed in said base material, for use in the process according to claim 1.

15. Fibre according to claim 14, wherein the base material is a thermoplastic material.

16. Fibre according to claim 14, wherein the glide material is a fluorinated plastic, PTFE, graphite, carbon black, a wax, some other glide-promoting substance or a mixture of two or more thereof.

17. Fibre according to claim 15, wherein the proportion of the fibre which is attributable to the glide material is 3% to 15%, preferably 7% to 10% and preferably 7% by weight.

18. Sheetlike article produced according to the process of claim 1.

19. Sheetlike article according to claim 18, wherein it is a ski skin, a slide-mat or a velour.

20. Sheetlike article according to claim 18, further comprising a supporting layer on which the glidable surface is formed by a pile secured on the supporting layer.
